(19) United States
(12) Patent Application Publication
(10) Pub. No.: US 2026/0340683 A1
(43) Pub. Date: Oct. 29, 2026

(54) INFORMATION PROVISION DEVICE, INFORMATION PROVISION METHOD, AND RECORDING MEDIUM

(71) Applicant: NEC Corporation, Minato-ku, Tokyo (JP)

(72) Inventors: Takashi SHIMIZU, Tokyo (JP); Takahiro MATSUI, Tokyo (JP); Shinji FUNAI, Tokyo (JP); Yoshiya UOTANI, Tokyo (JP)

(73) Assignee: NEC Corporation, Minato-ku, Tokyo (JP)

(21) Appl. No.: 19/123,097

(22) PCT Filed: Dec. 7, 2022
(86) PCT No.: PCT/JP2022/045196

§ 371 Date: Apr. 22, 2025

(51) Int. Cl. G06Q 30/0251

(52) U.S. Cl. CPC G06Q 30/0269

(57) ABSTRACT

An information provision device includes: a memory storing instructions; and at least one processor configured to execute the instructions to: detect a reaction of a customer to content output to any of output devices in a store; acquire information related to a product in a container for storing a product used by the customer when the detection is performed; determine, based on details of the content and the information related to the product in the container, advertisement information to be provided to the customer; and output the advertisement information to any of the output devices.

### TECHNICAL FIELD

The present disclosure relates to an information provision device, an information provision method, an information provision system, and a recording medium.

### BACKGROUND ART

There is a signage advertisement information distribution system capable of providing information of interest to a customer. For example, PTL 1 discloses that an advertisement or coupon information of a product is determined based on a history of reaction of a user to sales promotion information provided to a shopper.

### CITATION LIST

### Patent Literature

PTL 1: JP 2020-173711 A

### SUMMARY OF INVENTION

### Technical Problem

In a store, it is required to provide more effective advertisement information to a customer. In the technique described in PTL 1, the content of an advertisement is determined based on a behavior history of a customer including a reaction of a customer to sales promotion information. However, when the content of the advertisement is determined using the behavior history of the customer, information processing is complicated.

An object of the present disclosure is to provide an information provision device capable of providing effective advertisement information while suppressing a load of information processing.

### Solution to Problem

An information provision device according to an aspect of the present disclosure includes a detection means for detecting a reaction of a customer to content output to any of output devices in a store, an acquisition means for acquiring information related to a product in a product storage means used by the customer when the detection is performed, a determination means for determining, based on details of the content and the information related to the product in the product storage means, advertisement information to be provided to the customer, and an output means for outputting the advertisement information to any of the output devices.

An information provision method according to an aspect of the present disclosure executed by a computer, the method includes detecting a reaction of a customer to content output to any of output devices in a store, acquiring information related to a product in a product storage means used by the customer when the detection is performed, determining, based on details of the content and the information related to the product in the product storage means, advertisement information to be provided to the customer, and outputting the advertisement information to any of the output devices.

A recording medium according to an aspect of the present disclosure storing a program causes a computer to execute the steps of detecting a reaction of a customer to content output to any of output devices in a store, acquiring information related to a product in a product storage means used by the customer when the detection is performed, determining, based on details of the content and the information related to the product in the product storage means, advertisement information to be provided to the customer, and outputting the advertisement information to any of the output devices.

### Advantageous Effects of Invention

According to the present disclosure, it is possible to provide effective advertisement information while suppressing a load of information processing.

### BRIEF DESCRIPTION OF DRAWINGS

FIG. 1 is a block diagram illustrating a configuration example of an information provision device according to the first example embodiment.

FIG. 2 is a diagram illustrating a hardware configuration in which the information provision device according to the first example embodiment is implemented by a computer device and its peripheral device.

FIG. 3 is a diagram for describing a situation in which a detection unit detects a reaction of a customer.

FIG. 4 is an example of a screen of advertisement information output by an output unit according to the first example embodiment.

FIG. 5 is a flowchart illustrating an operation of information provision device in the first example embodiment.

FIG. 6 is a block diagram illustrating a configuration example of an information provision system according to a modification of the first example embodiment.

FIG. 7 is an example of a screen of advertisement information output by an output unit according to a modification of the first example embodiment.

FIG. 8 is another example of a screen of advertisement information output by an output unit according to a modification of the first example embodiment.

FIG. 9 is a block diagram illustrating a configuration example of an information provision system according to the second example embodiment.

### EXAMPLE EMBODIMENTS

Hereinafter, example embodiments of an information provision device, an information provision method, and a non-transitory recording medium recording a program according to the present disclosure will be described in detail with reference to the drawings. The present example embodiment does not limit the disclosed technology.

In the present example embodiment, content for a customer who is shopping is output to the output device in the store. The store is, for example, a retail store such as a supermarket and a home center. The content is an audio, a moving image, or a still image related to information about a store or a product. Examples of the output device include a customer terminal possessed by a customer, a tablet terminal provided in a shopping cart, a signage, and a speaker. The advertisement information in the present example embodiment is sales information about a specific product, and includes a feature, a price, a display place, inventory information, and the like of the product. The content in the present example embodiment includes content including advertisement information and content not including advertisement information. Details of the content is any content, and the content related to the plurality of products may be controlled to be output in a predetermined order.

An installation place of the output device is not particularly limited. For example, the output device may be installed near an entrance of a store, or may be installed on a product shelf, a door of the product shelf, a window of the store, a ceiling, or the like, and may be installed on a floor of the store.

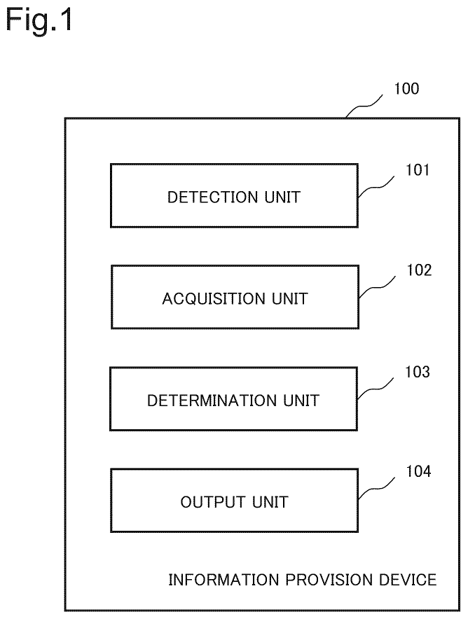

FIG. 1 is a block diagram illustrating a configuration example of an information provision system according to the first example embodiment.

Referring to FIG. 1, an information provision device 100 includes a detection unit 101, an acquisition unit 102, a determination unit 103, and an output unit 104.

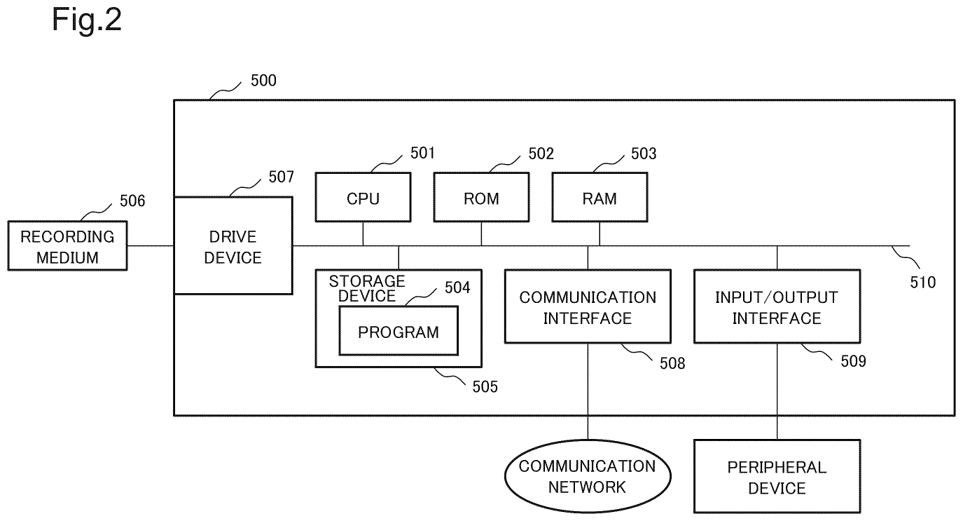

FIG. 2 is a diagram illustrating an example of a hardware configuration in which the information provision device 100 according to the first example embodiment of the present disclosure is implemented by a computer device 500 including a processor. As illustrated in FIG. 2, the information provision device 100 includes a memory such as a central processing unit (CPU) 501, a read only memory (ROM) 502, and a random access memory (RAM) 503, a storage device 505 such as a hard disk that stores a program 504, a communication interface 508 for network connection, and an input/output interface 509 that inputs and outputs data. In the first example embodiment, the information provision device 100 is connected to each component via a bus 510. The information provision device 100 according to the first example embodiment illustrated in FIG. 1 can also be configured by cloud computing or the like.

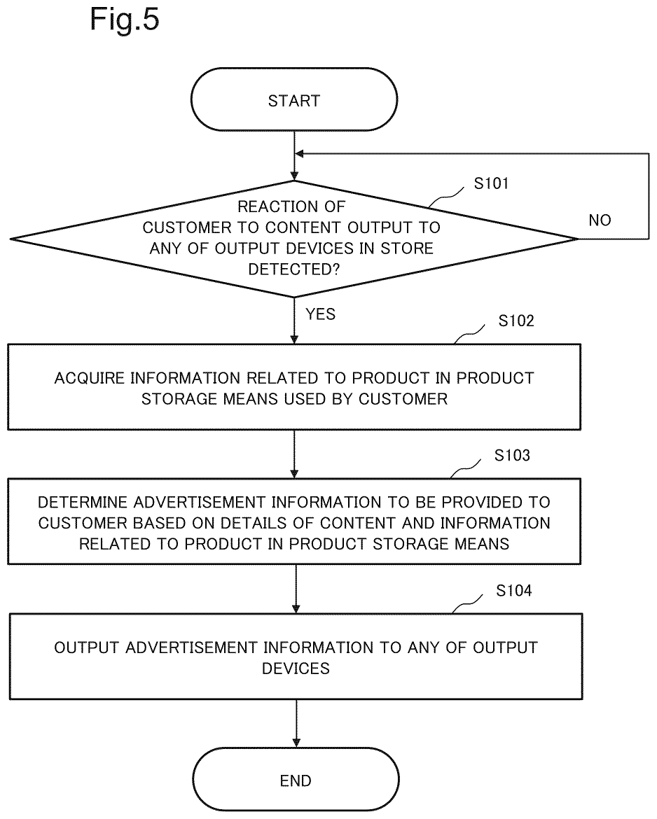

The CPU 501 operates an operating system to control the entire information provision device 100 according to the first example embodiment of the present invention. The CPU 501 reads a program and data from a recording medium 506 attached to a drive device 507 or the like to a memory, for example. The CPU 501 functions as the detection unit 101, the acquisition unit 102, the determination unit 103, the output unit 104, and part thereof in the first example embodiment, and executes processing or a command in the flowchart illustrated in FIG. 5 to be described later based on a program.

The recording medium 506 is, for example, an optical disk, a flexible disk, a magnetic optical disk, an external hard disk, a semiconductor memory, or the like. A semiconductor memory or the like which is part of the recording medium is a non-volatile storage device, and records a program therein. The program may be downloaded from an external computer (not illustrated) connected to a communication network.

As described above, the first example embodiment illustrated in FIG. 1 is implemented by the computer hardware illustrated in FIG. 2. However, the means for achieving each unit included in the information provision device 100 in FIG. 1 is not limited to the above-described configuration. Furthermore, the information provision device 100 may be achieved by one physically coupled device, or may be achieved by a system including two or more physically separated devices connected in a wired or wireless manner.

The detection unit 101 is a means for detecting the reaction of a customer to the content output to any of the output devices in the store. The reaction is a behavior that indicates an interest of the customer in the content. The reaction includes behavior of viewing or listening to the content and behavior after visually recognizing or listening to the content. As the visual recognition of the content, the detection unit 101 may detect that the content is visually recognized in a case where the customer has visually recognized the content for a predetermined time or more. The detection unit 101 may detect that the content of the products included in the same category are visually recognized a plurality of times by different output devices. In a case where the content is audio, the detection unit 101 may detect a behavior of turning around in the direction of the speaker that outputs the audio of the content, or may detect a behavior of stopping and listening to the audio of the content.

The detection unit 101 may detect an action in which the customer approaches the output device as an action after visually recognizing or listening to the content. The action also includes the line of sight of the customer. The detection unit 101 may detect an action in the customer prompts his or her fellow to see or listen to the content or that the customer has moved in the display direction of the product displayed on the content. The detection unit 101 may detect that the customer is positive to the details of the content based on the motion of the mouth or the expression of the customer. The detection unit 101 may change the criterion of the behavior to be detected according to the attribute of the customer, or may detect the degree of interest in the product included in the content of the customer according to the content of the detected behavior. However, the detection by the detection unit 101 is not limited to the above-described example, and a known method can be used.

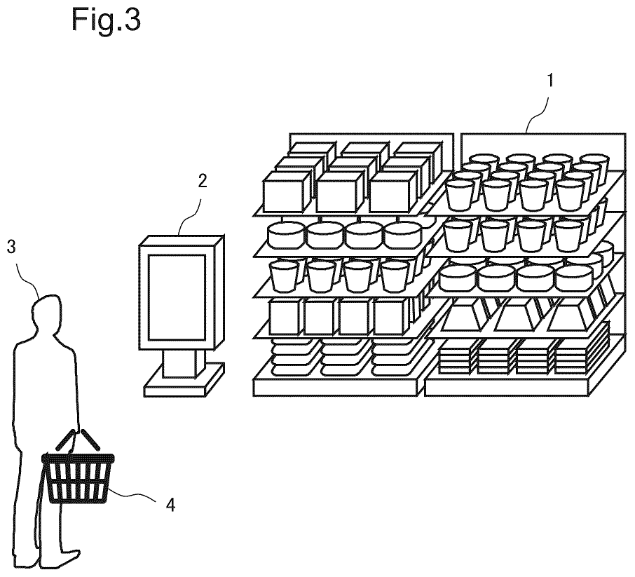

FIG. 3 is a diagram for describing a situation in which the detection unit 101 detects a reaction of a customer. In the example of FIG. 3, in a store, a signage 2 is installed as an output device beside a product shelf 1, and a customer 3 visually recognizes content displayed on the signage 2. The detection unit 101 may detect a reaction of the customer 3 based on an image captured by an imaging element provided in the signage 2, or may detect a reaction of the customer 3 based on an image captured by a monitoring camera installed in a store.

The acquisition unit 102 is a means for acquiring information related to the product in the product storage means used by the customer when detecting the reaction of a customer. The product storage means is a container for storing a product purchased by a customer, and is, for example, a shopping basket or a shopping cart. The shopping cart may be a smart shopping cart equipped with a product scanning function. The shopping cart may be provided with a tablet terminal having a display. In the example of FIG. 3, customer 3 uses a shopping basket 4. The product information is information about the product put in the product storage means, and refers to scanned product information in the case of a product storage means equipped with a scan function.

The acquisition unit 102 identifies a product storage means used by the customer who has reacted to the content based on the image photographed for detecting the reaction of a customer. The acquisition unit 102 identifies the product storage means possessed by the customer or the product storage means placed at a predetermined distance from the customer as a product storage means used by the customer. For example, identification information such as a mark is attached to each product storage means, and the acquisition unit 102 acquires the identification information about the product storage means to be identified by image recognition. Each product storage means has a radio frequency identification (RFID) tag in which identification information is recorded, and the acquisition unit 102 may acquire the identification information about the product storage means to be identified by the RFID reading means. Next, the acquisition unit 102 reads an identification code attached to a product with, for example, a camera or a scanner, and acquires product information. The acquisition unit 102 may acquire the product information by analyzing a product image acquired by a camera or the like provided at a position where the content of the product storage means is visible. The acquisition unit 102 may acquire the product information by analyzing an image captured by a security camera in the store.

The determination unit 103 is a means for determining advertisement information to be provided to the customer based on the details of the content and the information related to the product in the product storage means. For example, the determination unit 103 analyzes a product that is likely to be purchased by the customer based on the product information, and selects a product to which the advertisement information is to be provided from products that are identical to or related to the product included in the content based on a result of the analysis.

For example, the determination unit 103 analyzes the purchase trend of the customer from information related to the product in the product storage means of the customer as the product that the customer is likely to purchase. In a case where low-price products are included in a predetermined ratio or more in the product information about the customer, the determination unit 103 analyzes that the purchase trend of the customer is price-oriented. On the other hand, in a case where high-quality products are included in a predetermined ratio or more in the product information about the customer, the determination unit 103 analyzes that the purchase trend of the customer is quality-oriented.

For example, the determination unit 103 estimates a dish to be made from product information about a customer as a product that the customer is likely to purchase, and analyzes other food materials and the like necessary for making the dish. The determination unit 103 may further determine to provide the advertisement information about the product matching the purchase trend of the customer from the food materials, or may determine to provide the advertisement information about the product whose stock quantity in the store is equal to or greater than a predetermined quantity from the food materials.

The determination unit 103 may determine to provide the advertisement information about the product of the category not included in the product information about the customer. On the other hand, in a case where a predetermined number or more of products of a specific category are included in the product information about the customer, the determination unit 103 may determine to provide the advertisement information about another product of the category. The category of the product may be a large classification such as a sales floors of vegetables, meat, confectionery, frozen food, fresh food, and seasoning. The category of the product may be a small classification such as potato chips or curry roux. The category of the product may be both a large classification and a small classification. Also in this case, the determination unit 103 may further determine to provide the advertisement information about the product matching the customer's purchase trend from the food materials, or may determine to provide the advertisement information about the product whose stock quantity in the store is equal to or greater than a predetermined quantity from the food materials.

The determination unit 103 may determine to provide a plurality of pieces of advertisement information. In a case where a plurality of pieces of advertisement information is for a product displayed in a distant sales floor, a place of an output device that provides each piece of advertisement information may be identified.

The output unit 104 is a means for outputting advertisement information to any of the output devices. The output unit 104 outputs the advertisement information to any output device in the store. The output unit 104 may output the advertisement information to an output device located within a predetermined distance from a customer whose appearance matches that of the customer who has reacted to the content. The output unit 104 may output the advertisement information to the output device same as the output device that displays the content.

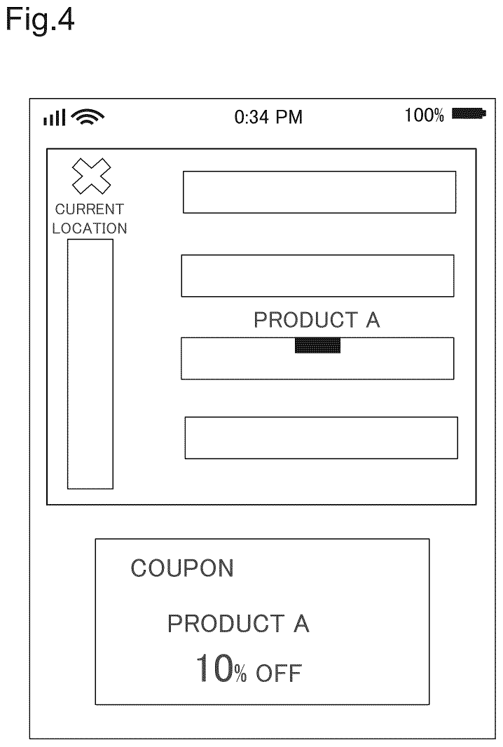

The output unit 104 outputs, as the advertisement information, for example, an area map indicating a display place of the product to be advertised, a coupon, price change information, or stock replenishment information. FIG. 4 is an example of a screen of advertisement information output by the output unit 104. In the example of FIG. 4, an area map indicating a display place of a product and a coupon are output. The price change information is information indicating that the price of the product to be advertised has decreased. The stock replenishment information is information indicating that the product to be advertised is replenished to the product shelf. However, the information output by the output unit 104 is not limited thereto as long as the information is information related to the product to be advertised.

The output unit 104 may output the advertisement information to a receipt issued after the checkout of the product. A two-dimensional barcode for outputting advertisement information may be attached to the product storage means or the receipt. In this case, the output unit 104 displays the advertisement information associated with the two-dimensional barcode on the customer terminal with reading of the information about the two-dimensional barcode by the customer terminal as a trigger.

In the present example embodiment, the detection unit 101 may detect the reaction of a customer to the content displayed on the signage among the output devices in the store, and the output unit 104 may output the advertisement information to the display of the product storage means or the customer terminal. In this case, for example, the detailed information about the product can be provided to the display of the product storage means or the customer terminal for the customer who has shown an interest in the product of the content displayed on the signage.

In the present example embodiment, the detection unit 101 may detect a reaction of a customer to the content displayed on the display of the product storage means or the customer terminal among the output devices in the store, and the output unit 104 may output the advertisement information to the signage in the store. In this case, for example, the information about the product can be provided on an easily viewable screen to the customer who has shown an interest in the product on the display of the product storage means or the content of the customer terminal.

FIG. 5 is a flowchart illustrating an outline of the operation of the information provision device 100 according to the first example embodiment. The processing according to this flowchart may be executed based on program control by the processor described above. The processing according to this flowchart is executed every time the detection unit 101 detects a reaction of a customer to the content output to any of the output devices in the store.

FIG. 5 is a flowchart illustrating the operation of the information provision device 100 according to the first example embodiment. In a case where the detection unit 101 detects a reaction of a customer to the content output to any of the output devices in the store (step S101; YES), the acquisition unit 102 acquires information related to the product in the product storage means used by the customer (step S102). Next, the determination unit 103 determines advertisement information to be provided to the customer based on the details of the content and information related to the product in the product storage means (step S103). The output unit 104 outputs the advertisement information to any of the output devices (step S104). As described above, the information provision device 100 ends the information provision processing.

As described above, in the first exemplary example embodiment, in the information provision device 100, the determination unit 103 determines advertisement information to be provided to the customer based on the details of the content to which the customer has reacted and information related to the product in the product storage means, and the output unit 104 outputs the advertisement information to any of the output devices. In this case, for example, it is possible to provide advertisement information about a product that is likely to be purchased by the customer without tracking the behavior history of the customer. Therefore, it is possible to provide effective advertisement information while suppressing the load of information processing.

### Modification of First Example Embodiment

Next, a modification of the first example embodiment of the present disclosure will be described in detail with reference to the drawings. Hereinafter, description of the content overlapping with the above description will be omitted to the extent that the description of the present example embodiment is not unclear.

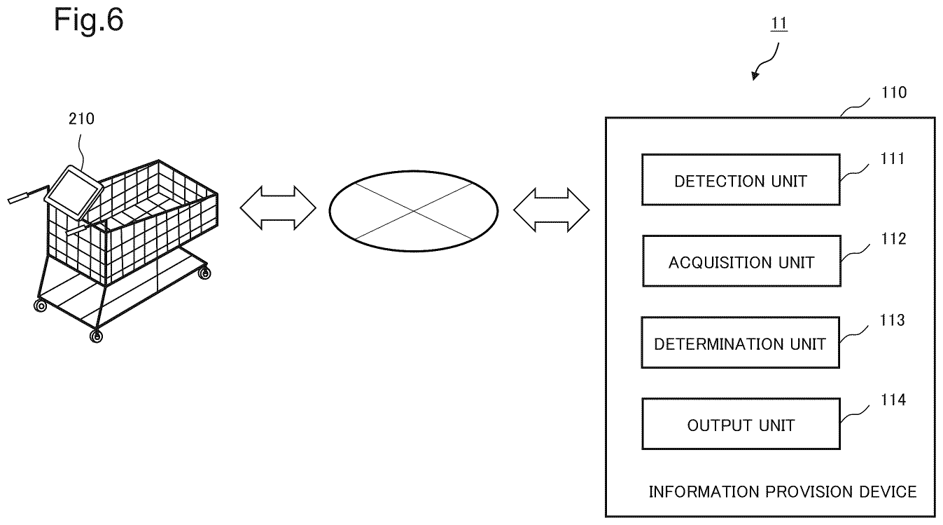

FIG. 6 is a block diagram illustrating a configuration example of an information provision system 11 according to the modification of the first example embodiment. An information provision device 110 is connected to a customer terminal 210 via a communication network. The customer terminal 210 may be a customer's own terminal device or a terminal device lent from a store for shopping. As illustrated in FIG. 6, the terminal may be a tablet terminal mounted on a shopping cart.

In the customer terminal 210, an application program for shopping in a store is installed in advance, and store information of the store to shop is selected. The product information is scanned by the customer and held on the application program. As in the computer device illustrated in FIG. 2, the functions of the information provision device 110 and the customer terminal 210 can be achieved not only by hardware but also by a computer device and software based on program control.

In the modification of the first exemplary example embodiment, a detection unit 111 may detect an action of operating content displayed on customer terminal 210 in addition to a method of detecting a reaction of a customer by the detection unit 101.

First, an acquisition unit 112 identifies a customer who has reacted to the content based on the position of the customer terminal 210. The acquisition unit 112 may identify a position of the customer terminal 210 based on the GPS information, and may identify a customer identification (ID) on an application program of a customer near an output device that displays content. As another example, the acquisition unit 112 may identify the customer ID near the output device that displays the content based on, for example, the store information selected on the application program and the position of the customer terminal 210 identified by the radio field strength by the wireless communication between the customer terminal 210 using the near field communication by Bluetooth Low Energy (BLE) and the communication device disposed in the store. After identifying the customer ID, the acquisition unit 112 acquires the product information about the customer through the communication interface 508.

In the modification of the first example embodiment, in addition to the method of determining the advertisement information by a determination unit 103, the determination unit 113 may determine the advertisement information by using attribute information such as gender and age of the user registered in association with the customer ID of the application program, and customer information such as a purchase history and a line of flow analysis result. In this case, the determination unit 113 can determine to provide the advertisement information about the product more matching the customer's preference.

In the present example embodiment, an output unit 114 may output the advertisement information through the application program.

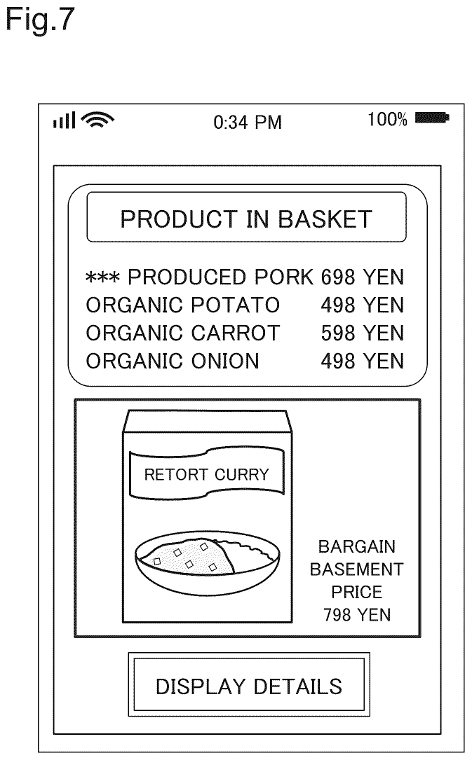

FIG. 7 is an example of a screen of advertisement information output by the output unit 114. In the example of the screen of FIG. 7, in addition to information related to the product in the product storage means of the customer, advertisement information to be provided to the customer is displayed on the application program. In FIG. 7, examples of information related to the product in the product storage means (basket) include “ * * * -produced pork”, “organic potato”, “organic carrot”, and “organic onion” having high quality. Therefore, the determination unit 103 analyzes that the customer's purchase trend is quality-oriented. Since the food material is necessary for curry, the determination unit 113 determines to provide the advertisement information about high-quality curry roux as a food material not in the product storage means. The output unit 114 displays the advertisement information about high-quality curry roux on the application program.

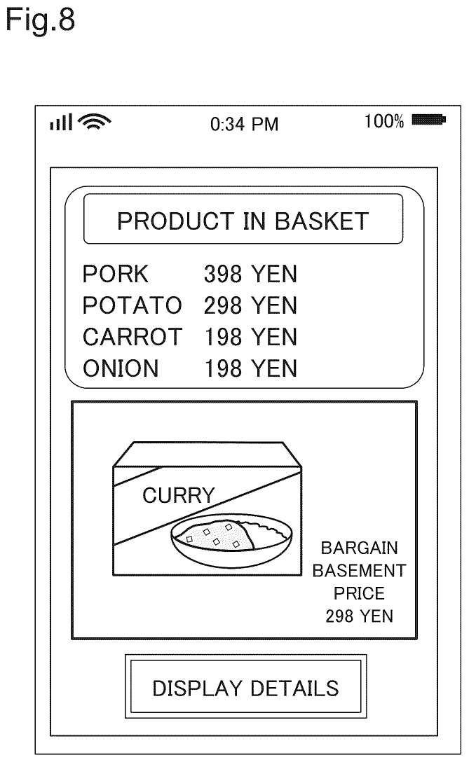

FIG. 8 is another example of the screen of the advertisement information output by the output unit. In the example of FIG. 8, low price “pork”, “potato”, “carrot” and “onion” are displayed as information related to the product in the product storage means (basket). Therefore, the determination unit 113 analyzes that the customer's purchase trend is price-oriented. Since information related to the product in the product storage means is a food material necessary for curry, the determination unit 113 determines to provide the advertisement information about inexpensive curry roux as a food material not in the product storage means. The output unit 114 displays the advertisement information about the inexpensive curry roux on the application program.

As described above, in the modification of the first example embodiment, in the information provision device 110, the acquisition unit 112 acquires the product information registered on the application program of the identified customer as information related to the product in the product storage means. In this case, for example, since the product information can be acquired more easily, the load of the information processing can be further suppressed.

### Second Example Embodiment

Next, the second example embodiment of the present disclosure will be described in detail with reference to the drawings. Hereinafter, description of the content overlapping with the above description will be omitted to the extent that the description of the present example embodiment is not unclear.

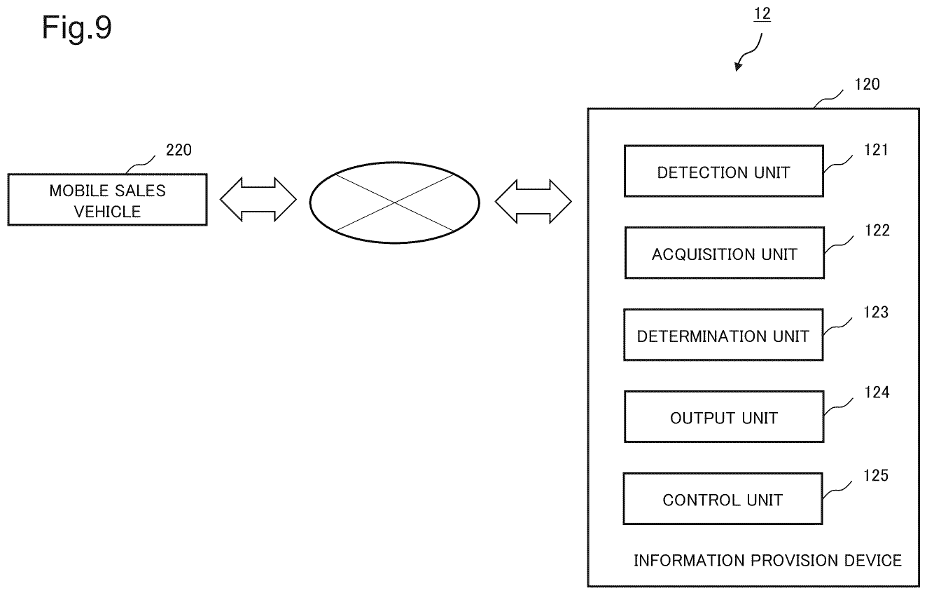

FIG. 9 is a block diagram illustrating a configuration example of an information provision system 12 according to the second example embodiment. An information provision device 120 is connected to a mobile sales vehicle 220 via a communication network. As in the computer device illustrated in FIG. 2, the functions of the information provision device 120 and the mobile sales vehicle 220 can be achieved not only by hardware but also by a computer device and software based on program control.

The mobile sales vehicle 220 is, for example, a self-propelled product shelf or wagon, and is not particularly limited as long as it has a structure capable of moving in a store in a state where products are displayed. The mobile sales vehicle 220 moves to the destination in accordance with the signal from the information provision device 120, triggered by the reception of the signal including the destination location from the information provision device 120. In the present example embodiment, the information provision device 120 stores a list of products displayed on the mobile sales vehicle 220 in the store in the storage device 505.

The information provision device 120 includes a control unit 125 that controls the position of the mobile sales vehicle 220 in the store, in addition to the components of the information provision device 100 in the first example embodiment. In a case where a product included in the advertisement information is displayed on any of the mobile sales vehicle 220 in the store, the control unit 125 moves the mobile sales vehicle 220 to a place through which the customer passes. The control unit 125 designates, as the place through which the customer passes, for example, an any place advanced by a predetermined distance along the shopping path set by the store side from the position of the output device that displays the content in which the reaction of a customer is detected. However, the place where the control unit 125 moves the mobile sales vehicle 220 is not limited to this, and the place through which the customer passes may be estimated by analyzing the past line of flow of the customer. In the present example embodiment, an output unit 124 may output that the product included in the advertisement information has been moved close to the customer.

As described above, in the second exemplary example embodiment, in a case where a product included in advertisement information is displayed on any of the mobile sales vehicle 220, the control unit 125 of the information provision device 120 moves the mobile sales vehicle 220 to a place through which a customer passes. In this case, even when the customer does not go to the display place of the product, the customer can be brought close to the display place of the product.

While the present disclosure has been particularly shown and described with reference to each of example embodiments, the present disclosure is not limited to the above example embodiments. The configurations and details of the present disclosure may include example embodiments to which various changes that can be grasped by those of ordinary skill in the art without departing from the scope of the present disclosure are applied. The present disclosure may include example embodiments in which the matters described in the present specification are appropriately combined or replaced as necessary. For example, the matters described using a specific example embodiment can be applied to other example embodiments as long as no contradiction occurs. For example, although the plurality of operations is described in order in the form of a flowchart, the order of description does not limit the order in which the plurality of operations is executed. Therefore, when each example embodiment is implemented, the order of the plurality of operations can be changed within a range that does not interfere with the content.

### REFERENCE SIGNS LIST

11, 12 information provision system
100, 110, 120 information provision device
101, 111, 121 detection unit
102, 112, 122 acquisition unit
103, 113, 123 determination unit
104, 114, 124 output unit
125 control unit
210 customer terminal
220 mobile sales vehicle
500 computer device
501 CPU
502 ROM
503 RAM
504 program
505 storage device
506 recording medium
507 drive device
508 communication interface
509 input/output interface
510 bus

What is claimed is:

1. An information provision device comprises:
a memory storing instructions; and
at least one processor configured to execute the instructions to:
detect a reaction of a customer to content output to any of output devices in a store;
acquire information related to a product in a container for storing a product used by the customer when the detection is performed;
determine, based on details of the content and the information related to the product in the container, advertisement information to be provided to the customer; and
output the advertisement information to any of the output devices.

2. The information provision device according to claim 1, wherein
the at least one processor is further configured to execute the instructions to:
analyze a product that is likely to be purchased by the customer based on the product information; and
select a product to which the advertisement information is to be provided from products that are identical to or related to a product included in the content based on a result of the analysis.

3. The information provision device according to claim 1, wherein
the at least one processor is further configured to execute the instructions to:
output the advertisement information to an output device located within a predetermined distance from a customer whose appearance matches an appearance of the customer who has reacted to the content.

4. The information provision device according to claim 1, wherein
the at least one processor is further configured to execute the instructions to:
detect a reaction of a customer to content displayed on a signage in the store, and
output advertisement information to a display of the container product storage means or a customer terminal.

5. The information provision device according to claim 1, wherein
the at least one processor is further configured to execute the instructions to:
detect a reaction of a customer to content displayed on a display of the container or a customer terminal, and
output advertisement information to a signage in the store.

6. The information provision device according to claim 1, wherein
the at least one processor is further configured to execute the instructions to:
the container is in an application program installed in a terminal used by the customer, and
acquire the product information registered in the application program of the customer identified based on a position of the terminal.

7. The information provision device according to claim 1, wherein
the at least one processor is further configured to execute the instructions to:
output, as the advertisement information, an area map, a coupon, price change information, or stock replenishment information related to a product to be advertised.

8. (canceled)

9. An information provision method executed by a computer, the method comprising:
detecting a reaction of a customer to content output to any of output devices in a store;
acquiring information related to a product in a container for storing a product used by the customer when the detection is performed;
determining, based on details of the content and the information related to the product in the container, advertisement information to be provided to the customer; and
outputting the advertisement information to any of the output devices.

10. A non-transitory recording medium storing a program for causing a computer to execute the steps of:
detecting a reaction of a customer to content output to any of output devices in a store;
acquiring information related to a product in a container for storing a product used by the customer when the detection is performed;
determining, based on details of the content and the information related to the product in the container, advertisement information to be provided to the customer; and
outputting the advertisement information to any of the output devices.
